(19) United States
(12) Patent Application Publication
(10) Pub. No.: US 2002/0014515 A1
(43) Pub. Date: Feb. 7, 2002

(54) Method of self-correcting bond placement errors of integrated circuit bonders

(76) Inventor: Sreenivasan K. Koduri, Plano, TX (US)

Correspondence Address: Gary C. Honeycutt, Godwin White Gruber, PC., Suite 655, 801 E. Campbell Rd., Richardson, TX, 75081, US

(21) Appl. No.: 09/920,006

(22) Filed: Aug. 1, 2001

Related U.S. Application Data
(60) Provisional application No. 60/222,529, filed on Aug. 2, 2000.

(51) Int. Cl. B23K 31/12; B23K 1/00

(52) U.S. Cl. 228/105; 228/103; 228/10; 228/9

(57) ABSTRACT

A computerized system and method for identifying and correcting bond placement errors in a bonder pre-programmed to attach connecting bonds onto bond pads of an integrated circuit by first providing a sacrificial bond pad for a sacrificial bond, then using a vision system associated with the bonder to determine the actual center of the pad as the intended bond location, and instructing the bonder to place a bond in the pre-programmed center of the pad. Second, the vision system is used to determine the actual location of the bond. Next, the error between the intended location and the actual location is determined by computing distances and directions between the pre-programmed and actual centers and the actual bond location. Finally, a new command of the bonder is computed such that a repetition of the initial error would cause the bond to be located in the actual center of another pad. This new command is input to the bonder.

### FIELD OF THE INVENTION

The present invention is related in general to the field of semiconductor devices and electronic systems and more specifically to a self-correcting system for accurate placement in computer-controlled bonding machines used in integrated circuit assembly.

### DESCRIPTION OF THE RELATED ART

In integrated circuit (IC) assembly, an IC chip is typically mounted on a leadframe and electrically connected to it by metallic segments. Commonly, the chip assembly is encapsulated in a protective package (for instance, ceramic package, or plastic package using molding process). Typically, the IC chip has a plurality of bond pads, which are often positioned around the chip perimeter; these bond pads have predetermined bonding area and spacing (bond pad pitch). The leadframe usually has a plurality of narrow “inner” leads for attachment to the segments and inclusion in the package, and a plurality of wider “outer” leads for attachment to other parts such as solder attachment to circuit boards.

The metallic segments used for electrical connection of the IC chip to the leadframe include wires and ribbons, and are attached by ball bonding, stitch bonding, or wedge bonding techniques. Wire bonding is a process in which a wire may be welded from a chip bond pad to the tip of an inner lead of the leadframe. As an example, in wire ball bonding the ball is attached to the chip bond pad and the stitch to the leadframe inner lead. For a given device type, there is a set of locations expressed in x and y coordinates which defines the bond locations on the chip and on the lead tips. These locations are generally stored collectively in a computer file, sometimes referred to as “Device Program”. Apart from the bond head, capable of providing x-y-z motion needed for bonding, a wire bonder has a material handling subsystem and the vision subsystem.

Conventional semiconductor computerized wire bonders use x-y tables to move the bonding capillary over the device for bonding between the chip and the leadframe. The x-y coordinate tables are driven by complex electrical and mechanical components that may convert rotary and linear motions of the axis drive motors to create the needed positioning. The bond head also carries several other components such as the z-axis drive motor, a camera and optics for vision functions, and further components required to control wire bonding. Specific features of the capillary and its alignment are described in a number of U.S. Patents and Patent Applications. Examples are: U.S. Pat. No. 5,934,543, issued on Aug. 10, 1999 (Koduri et al., “Wire Bonding Capillary having Alignment Features”); and application Ser. No. 08/993,638, filed on Dec. 18, 1997 (Koduri, “Wire Bonding with Capillary Realignment”). The interaction of capillary and vision system is illustrated, for example, by U.S. patent application Ser. No. 09/191,812, filed on Nov. 13, 1998 (Koduri et al., “Automation of Optics Offset Measurement on Wire Bonders”); Ser. No. 09/111,642, filed on Jul. 8, 1998 (Koduri et al., “An Efficient Hybrid Illuminator”);Ser. No. 09/111,977, filed on Jul. 8, 1998 (Koduri et al., “An Efficient Illumination System for Wire Bonders”).

The material handling system moves a leadframe so that each device can eventually be placed under the bond head for bonding. One or more devices may be placed under the bond head at a time to be bonded. The device may also be heated in a predetermined manner to establish reliable metallurgical bonding conditions. After a device has been bonded, the leadframe is step-moved such that the next unit can be bonded.

When a unit is indexed in by the material handling system for bonding, the position of the leadframe and the chip is not always the same because of variations in the handling and previous manufacturing (such as variable chip positioning during attachment to the leadframe). Without knowing accurately the target bonding locations, the bond head cannot place the bonds as expected. To aid this process, a machine vision system is employed. A typical vision system consists of a set of optics to provide the needed illumination and magnification of the device, a camera to capture the image provided by the optics and an image processing system to store and analyze the captured image.

Before bonding a device, it is essential to determine the device program with all the coordinate locations of the bonds that need to be created. With respect to a predetermined set of reference locations, those locations are often referred to as “homes”. A typical device may have one or more “homes”. Generally, the identification of homes needs to be done individually for each device to be bonded. It is common practice to use a three-step process to enable such identification.

In the step of “teaching”, the coordinate locations of the homes and all the needed bonds are identified and saved to create the “device program”. Once generated, a device program can be stored, copied and/or shared between multiple machines as needed.

In the step of “regeneration”, a human operator helps in locating the homes of the first device after loading in the information from the previously saved device program. At this point, the machine captures and saves a set of images, called “reference images” or “references” in the neighborhood of each home.

In the step of “bonding”, the machine indexes one unit or more at a time into the workstation under the bond head. At this point, the vision system, with the aid of a pattern recognition system, attempts to relocate the matching locations with the saved references. After finding the new coordinates of the matching references, the home and bond locations are re-computed for that specific unit from the device program data. The process of relocating the references and homes is normally referred to as “aligning” the device. Using the specific bond locations, the device can now be bonded. The process of indexing, aligning and bonding is repeated without any human intervention as long as nothing abnormal happens on the machine.

A typical alignment procedure may correct for a constant shift in x-y directions and/or a constant rotation of the device. In this context, it is important to understand the effects of variations in illumination settings across machines and the images formed using different levels of brightness. Large differences in intensity settings can reduce the ability of the pattern recognition system to locate the references accurately. It is very much desired to have a consistent level of brightness and image quality across all the machines used.

Problems in wire bonding techniques arise in part from the technology trends to increase the number of leads in a given package and to make IC chip packages smaller. As consequences, the bonding pads located on the chip receive smaller areas and are spaced closer together, and the inner leads of leadframes are made narrower and closer together. These trends demand tighter control of wire bond ball and stitch geometries and placements. For instance, even small bond placement errors may result in device loss.

For the bond machines, errors in x-y tables and motors need to be reduced. At the microscopic level, each axis of each table behaves differently with its own local variations within their usable regime. Further, a x-y pair might have a global positioning error because of an error in the orthogonality between them; or the tables may exhibit a range of hysteresis errors. These variations become even more threatening as common device programs are shared due to quality enforcement and economic reasons.

The emerging technical problems for automated bond machines can be summarized as follows:

Accuracy: Small ball/fine pitch bonding requires a very accurate system to be able to place the ball completely on the bond pad. The current systems have difficulties in achieving this.

Large variations in illumination settings can lead to variations of the images as seen by the optics and the camera.

The current systems cannot handle x-y table inconsistencies. For small pad/fine pitch bonding, a small error in ball placement can cause the ball to be partially off the pad.

Human error during regeneration of alignment program: Ball placement is greatly affected by the accuracy of the alignment program. There are many steps to this regeneration process and thus there are many chances for human error.

Time spent performing alignment regeneration: Whenever a device is to be bonded, a human operator typically has to spend a finite amount of time to perform an alignment regeneration.

U.S. patent application No. 60/201,910, filed on May 4, 2000 (Koduri et al., “System and Method to Reduce Bond Program Errors of Integrated Circuit Bonders”), No. 60/204,997, filed on May 16, 2000 (Bon et al., “System and Method to Customize Bond Programs Compensating Integrated Circuit Bonder Variability”), and No. 60/206,493, filed on May 23, 2000 (Koduri et al., “System and Method to Recreate Illumination Conditions on Integrated Circuit Bonders”) describe methods how a network of relationships between reference images, bond locations, and illumination conditions can be used to adaptively compensate for variable characteristics of a slave circuit compared to a master circuit, and a slave bonder compared to a master bonder. The present invention is related to these patent applications. Unfortunately, however, they do not address methods how an individual bonder can correct gradual and systematic errors, or random and unpredictable errors in the bond pads or in the bonding operation.

An urgent need has therefore arisen for a fast, reliable and flexible system and method to identify and correct bond placement errors in a bonder pre-programmed to attach connecting bonds onto bond pads of an integrated circuit. The system and method should be flexible enough to be applied for different IC product families with a wide spectrum of design variations, and for different bond machines. The system and method should spearhead solutions toward the goals of improved product yield and reliability, preferably without investment in new equipment.

### SUMMARY OF THE INVENTION

The present invention provides a computerized system and method for identifying and correcting bond placement errors in a bonder pre-programmed to attach connecting bonds onto bond pads of an integrated circuit by first providing a sacrificial bond pad for a sacrificial bond, then using a vision system associated with the bonder to determine the actual center of the pad as the intended bond location, and instructing the bonder to place a bond in the pre-programmed center of the pad. Second, the vision system is used to determine the actual location of the bond. Next, the error between the intended location and the actual location is determined by computing distances and directions between the pre-programmed and actual centers and the actual bond location. Finally, a new command of the bonder is computed such that a repetition of the initial error would cause the bond to be located in the actual center of another pad. This new command is input to the bonder.

The present invention is related to high density ICs, especially those having high numbers of input/outputs and tight constraints in package outline and profile. These ICs can be found in many semiconductor device families such as processors, standard linear and logic products, digital and analog devices, high frequency and high power devices, and both large and small area chip categories. Since the invention aims at designing devices with minimum geometries and high reliability, it supports continually shrinking applications such as cellular communications, pagers, hard disk drives, laptop computers and medical instrumentation.

It is an object of the present invention to provide an automated system and method for self-correcting bond placement errors. It is another object of the present invention is to provide a highly flexible system and method. These objects are achieved by the embodiments of two subsystems of the invention:

An automated method to determine the error by choosing an origin as point of reference; computing distance and direction of the pre-programmed center form the origin; computing distance and direction of the actual bond location from the pre-programmed center; computing distance and direction of the actual center from the pre-programmed center; and finally computing distance and direction of the actual center from the actual bond location.

An automated method to compute a new command by computing a new center of the pad by adding to the location of the pre-programmed center the distance and the direction of the actual center from the actual bond location, and then implementing the new center into the bonder as the corrected pre-programmed center.

Another object of the present invention is to provide the newly computed command in fast turn-around time and with minimum effort by taking full advantage of the option of creating mathematically convenient points of origin.

Another object of the present invention is to introduce methods of self-correcting bond placement errors which are flexible so that they can be applied to many families of electronic structures—reaching from piece parts, such as leadframes and interconnectors, to device packages, to electronic substrates, and to whole assemblies on motherboards—and are general so that they can be applied to several generations of products.

Beyond the electronics realm, the computerized system and method of this invention can be generally applied to correct action errors on machines prepared to mechanically work on action sites of objects. The self-correcting system for accurate placement continuously monitors and corrects any deviation in the placement process, which requires high precision on equipment; besides wire bonding, examples are multiprobing or local actions such as hole drilling and nail attaching. A machine vision system in conjunction with a robotic placement mechanism mimics the human hand-eye coordination. The stringent requirements placed on the components can than be relaxed as any deviation in performance is going to be automatically corrected for.

The technical advances represented by the invention, as well as the objects thereof, will become apparent from the following description of the preferred embodiments of the invention, when considered in conjunction with the accompanying drawings and the novel features set forth in the appended claims.

### BRIEF DESCRIPTION OF THE DRAWINGS

FIG. 1 is a schematic and simplified top view of an integrated circuit (IC) chip illustrating bond pads with correctly placed bond attachments.

FIG. 2 is a schematic and simplified top view of an IC chip illustrating bond pads with erroneously placed bond attachments.

FIG. 3A is a schematic and simplified top view of an IC chip illustrating bond pads, with one pad marked for enlargement in FIG. 3B.

FIG. 3B is a schematic top view of an empty bond pad with the definitions of locations relevant for the present invention.

FIG. 4 explains the vectors connecting the locations defined in FIG. 3B.

FIG. 5 illustrates a first embodiment of the invention, explaining the mathematical steps for correcting placement errors, using the location definitions of FIG. 3B and the vectors definitions of FIG. 4.

FIG. 6 illustrates a second embodiment of the invention, explaining alternative mathematical steps for correcting placement errors.

FIG. 7 illustrates a block diagram of a computer system for identifying and correcting bond placement errors of a semiconductor chip assembly bonder according to the invention.

### DETAILED DESCRIPTION OF THE PREFERRED EMBODIMENTS

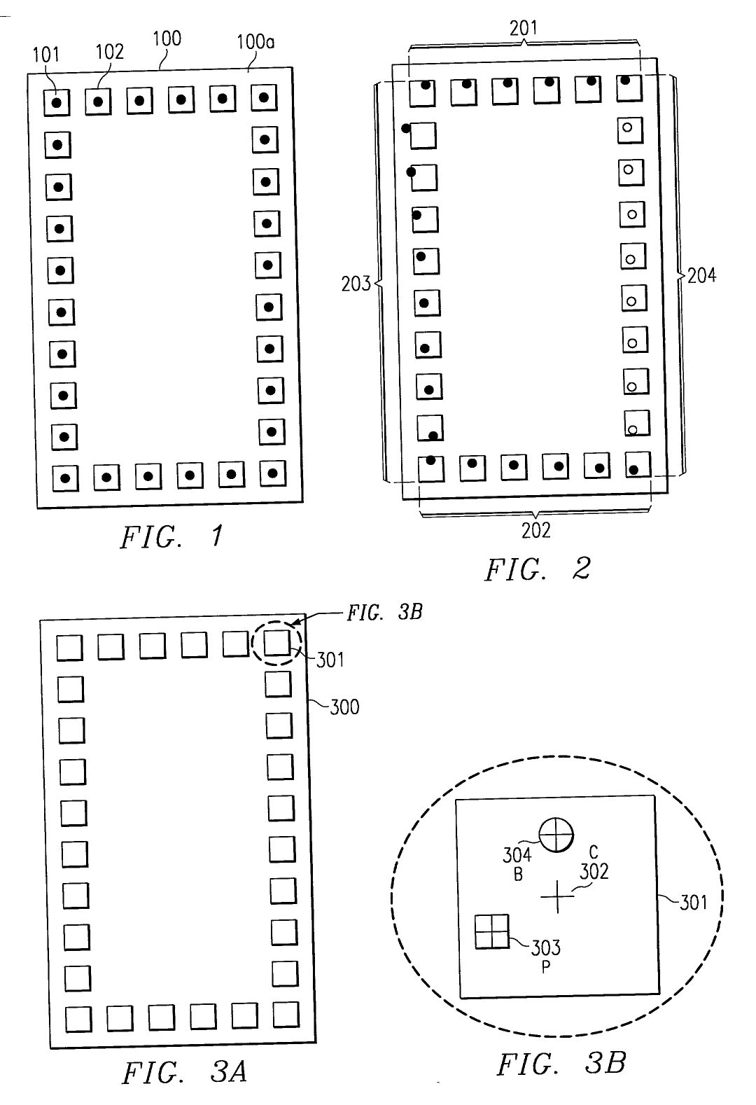

FIGS. 1 and 2 illustrate examples of the problems in semiconductor chip assembly and the errors in bonding operation addressed by the present invention. In FIG. 1, a plurality of bond pads 101 is provided on the active surface 100a of chip 100. In the ideal assembly case illustrated, all bonds 102 attached to pads 101 are located in the center of the pad areas. In FIG. 2, a similar plurality of bond pads is shown, but the bonds are located off the ideal locations in several ways. In the top row 201 of pads, all bonds are offset and shifted towards the pad perimeter (where probably all of them will represent a risk to the quality of the bonds and to the reliability of the material surrounding the pad area). In the bottom row 202 of pads, the bonds are gradually slanted (so that several of them fall outside of the range of acceptable bond). In the left hand row 203 of pads, the bonds are also gradually slanted (so much so that some bonds miss their pads altogether). In the right hand row 204 of pads, the bond are spread out and misplaced without a general trend (possibly caused by non-linearities in the axis of the row or by gradual thermal expansion of the chip).

It should be pointed out that errors as depicted in FIG. 2 may be developing gradually over time and may be systematic. On the other hand, other errors emerge at random and unpredictably. Numerous causes contribute to this undesirable behavior. The capillary as the bonding tool is typically made of ceramic or ruby materials; however, its holding and moving fixture, is made of metal. Further, the motors, tables, and optics are made different materials. In addition to material and mechanical differences, there are harsh thermal and ultrasonic effects, because the bonding operations are performed at elevated temperatures, and during bonding, mechanical pressure and ultrasonic energy are applied. Consequently, it is almost unavoidable that initial set-up conditions change after few operations. Corrective efforts by stabilizing components or environment have typically been found to be very expensive, or even impossible.

Any of the errors depicted in FIG. 2 can severely limit the ability of bonding machines (“bonders”) and thus the ability of producing smaller, faster ands lower cost devices economically. The solutions to these errors of known technology include building and testing the x-y tables for higher perfection - which is prohibitively expensive and often not acceptable to the existing fleet of machines. Other corrective efforts by stabilizing components or environment have typically been found to be very expensive, or even impossible.

In contrast, the present invention does not assume that the electromechanical components behave consistently in a predictable manner even for a short duration of time. Rather, the invention accepts that the operating components have a random error associated with them that cannot be pre-determined.

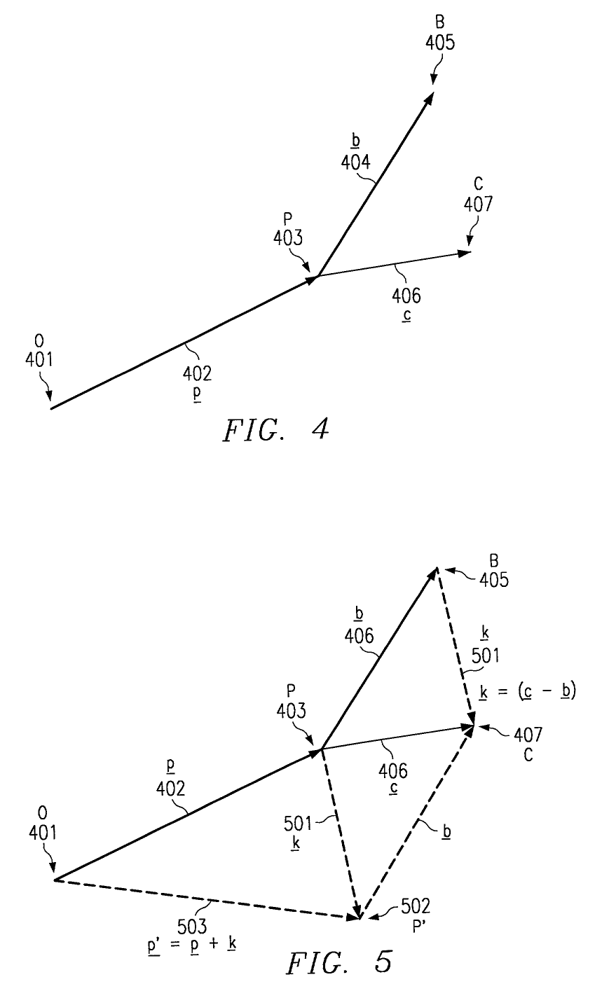

In order to highlight the conceptual breadth of the present invention, as summarized in FIG. 3A and 3B, it should be pointed out that the contributing innovations come from the following process steps:

Providing a sacrificial bond pad 301 of IC chip 300 for a sacrificial bond-to-be-performed;

employing the vision system, which is associated with the bonder, for generating the first input data: To determine the actual center C of the pad 301 as the intended bond location; in FIG. 3B, the actual center is designated 302;

instructing the bonder to place a bond in the pre-programmed center P of the pad 301; in FIG. 3B, this pre-programmed center is designated 303;

using the vision system for generating the second input data: To determine the actual location B of the bond; in FIG. 3B, this actual placement is designated 304;

feeding the first and second input data into an image comparator and determining the error between the intended location P (303) and the actual location B (304): To compute the distances and the directions between the pre-programmed center P (303), the actual center C (302), and the actual bond location B (304). The mathematical approach involving vectors is described below;

using the error data to compute a new command for the bonder such that a repetition of the initial error would cause the next bond to be located in the actual center C′ of another pad-to-be-bonded; and

inputting the new command into the bonder for corrected bonding actions.

Based on the method of the invention, the sequence of corrective steps can be repeated with any periodicity, including for each bond, or once for every chip, or after a pre-defined number of chips. Further, all kinds of bond placement errors can be corrected, including gradual and systematic errors as well as random and unpredictable errors.

The method of the invention applies to any kind of bonds including ball bonds, wedge bonds, stitch bonds, and balls, by using wires, ribbons, and bumps. In general, the method of the invention is applicable to any machine action involving localized action, such as attaching nails, drilling holes, or any other kind of repetitive mechanical process.

The mathematical process involving vectors can best be understood in conjunction with FIGS. 4, 5 and 6. In the figures and in the text, vectors are marked by underlined letters. The method of determining the bond placement error of the bonder is illustrated in FIG. 4; it involves the following process steps:

Choosing an origin O as point of reference; in FIG. 4, origin O is designated 401. Preferably, the origin is determined by alignment reference structures in the retriever of the bonder, which regenerates the master bond program stored in the device program file and relates it to an alignment reference;

computing vector p (designated 402 in FIG. 4) as the distance and direction of the pre-programmed center P (403 in FIG. 4) from origin O (401);

computing vector b (404 in FIG. 4) as the distance and direction of the actual bond location B (405) from the pre-programmed center P (403);

computing vector c (406 in FIG. 4) as the distance and direction of the actual pad center C (407) from the pre-programmed center P (403); and

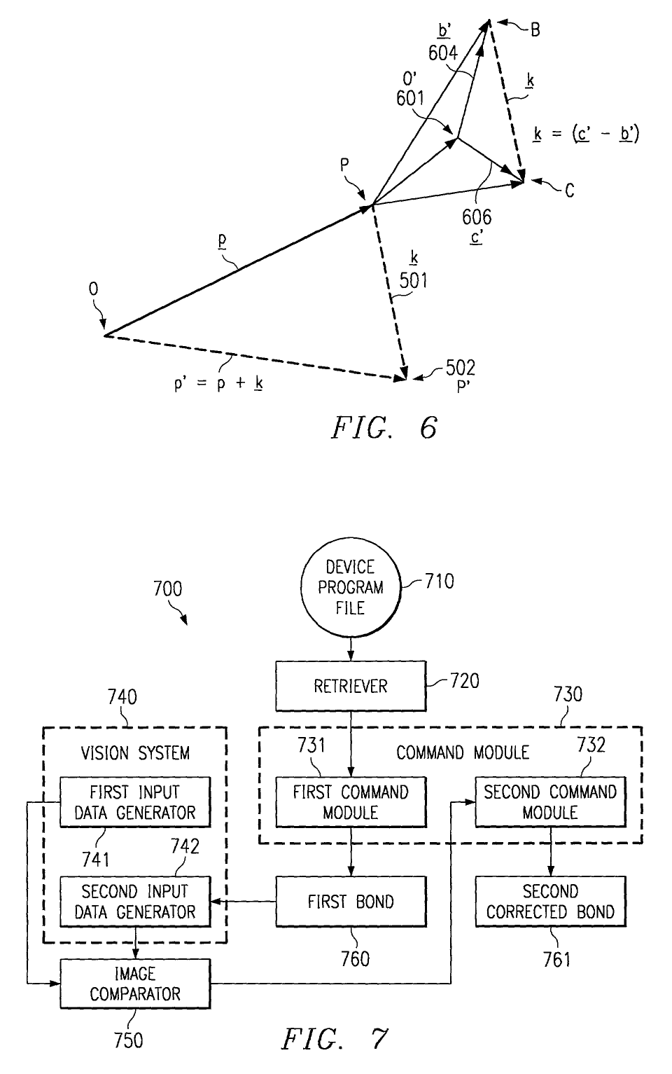

computing vector k (501 in FIG. 5) as the distance and direction of the actual center C (407 in FIGS. 4 and 5) from the actual bond location B (405 in FIGS. 4 and 5).

The automated computation of vector k is crucial for the present invention. By rules of vector algebra, vector k is the difference between vectors c and b: k=c−b. Vector k is needed for the process step of computing the new bonder command, creating the desired accurate bond placement.

According to FIG. 5, the computation of the new bonder command comprises the steps of:

Computing the “new center” P′ (designated 502 in FIG. 5) of the bond pad by adding to the location P (403 in FIGS. 4 and 5) of the pre-programmed center the vector k (501 in FIG. 5), as the distance and direction of the actual center C (407) from the actual bond location B (405); and

implementing the new center P′ as the corrected preprogrammed center into the bonder program.

When the bonder now repeats the initial placement error, the new bond will be located exactly in the actual center C (407) of the next pad-to-be-bonded.

The same result can be obtained by applying the rules of vector algebra in the following manner. Since one can directly only control the vector p (designated 402) and the position P (designated 403), how can one achieve the desired effect of having point B (405) coincide with point C (407)? As one is limited to controlling vector p, that question is equivalent to the question, what value of new vector p′ (designated 503 in FIG. 5) would produce a position P′ (502) that will move placement B (405) to coincide with center C (407)? According to vector algebra, p′=p+k. With p′, pre-programmed position P is changed to position P′, and with the knowledge of P′, the next bond can be placed exactly in the actual pad center C (407).

The knowledge of the coordinates of point P as the pre-programmed bond position can be obtained from the device program after correcting for the specific unit with an alignment system. Preferred procedures are described in the above-quoted U.S. patent application Ser. Nos. 60/201,910, 60/204,997, and 60/206,493, which are hereby incorporated by reference.

The knowledge of the coordinates of point C as the actual center of the bond pad may be obtained in all cases where the shape and/or size of the pad is known. Usually, an automated machine vision system is employed.

An alternative approach, which does not depend on having a predefined shape and size, consists of certain image identification/location methods, such as correlation and geometric search. Before beginning the process of bonding a batch of chips, the operator is interactively “teaching” a region or point of the chip where bonds have to be consistently placed. A picture of that neighborhood is taken with the help of the bonder-associated vision system and its camera, and stored for later use; it is referred to as the “pad reference image”. Once the bonding process has started, a picture of the chip may be taken (on every unit in the batch or with a pre-defined periodicity) right before bonding, and an automated search may be conducted with a previously saved “pad reference image” to locate the new pad center C. Together with center C, the vector c is identified.

In order to find the actual bond location B, it needs to be pointed out that the point B refers to the center of the actual bond as bonded. Experience teaches that the shape of the actual bond can be circular, elliptical, or crescent-formed, or may have various other contours and outlines. For wire ball bonds, the actual bond shapes can commonly be approximated by a circular ball. It is, therefore, practical to approximate the location of point B as the center of the bonded circular ball. An analogous method has been described in U.S. patent No. 5,991,436, issued on Nov. 23, 1999 (Koljonen et al., “Apparatus and Method for Inspecting Wire Bonds on Leads”). Together with point B, the vector b is identified.

As pointed out above, the knowledge of vectors c and b allows the computation of vector k, by k=c−b. This computation may be performed continuously on each bonded ball, or with a certain periodicity such as once for every chip or after a pre-defined number of chips. Alternatively, the frequency of updating the k vector may be automated following an arbitrary statistics. The same value of k may be used until a new one is computed.

Another embodiment of the present invention is based on the fact that picture-taking cameras have a limited field of vision. It is convenient to have points B and C in the same picture. Consequently, it may be preferable to relate point P to an origin O′ more conveniently located than the origin O used on FIGS. 4 and 5. Such origin O′ may be a one-time arbitrary choice as depicted in FIG. 6.

In FIG. 6, the arbitrary origin O′ is designated 601, with the new, different vectors b′ (604 in FIG. 6) and c′ (606). In spite of this change, FIG. 6 demonstrates that the vector k=c′−b′ remains the same as before. Consequently, also point P′ (designated 502 in FIG. 6) remains the same.

By using more than one point for correction, the method of this invention can be expanded to correct for non-linear defects such as scaling, rotation, skew, stretch, etc. The correction also may be applied globally to the whole chip or to local segments of the chip to correct for any local non-linear imperfections.

FIG. 7 illustrates a simplified block diagram of the computer system as disclosed by this invention for identifying and correcting bond placement errors of a semiconductor chip assembly bonder. In FIG. 7, the computerized system of the present invention, generally designated 700, operates to provide data generation as well as data analysis for creating corrected bonding instructions for the bonding process of an IC. The bonder is pre-programmed to attach connecting bonds onto bond pads of an integrated circuit, and the bonder has a vision system associated with it. The pre-generated device program file 710 operates to store the master bond program used for the pre-programming.

Device program file 710 is connected to a retriever 720. The retriever regenerates the master program and relates that program to alignment references. The retriever 720 is coupled to the command module 730 of the computerized bonder, specifically to the first command module 731 within command module 730.

The vision system 740, consisting of optics and a camera and associated with the bonder, provides the first input data generator 741. The input generator collects images from a sacrificial, still empty bond pad. Based on these input data, the actual center of the empty bond pad will automatically be determined. The data from the first input generator 741 are forwarded to the image comparator 750.

The first command module 731, located within the bonder command module 730 and coupled to the retriever 720, instructs the bonder to place a bond intended for the bond pad center according to the pre-program loaded into the bonder. Executing this instruction, the bonder, coupled to the first command module, attaches a first bond 760 to the sacrificial pad.

After first bond 760 has been completed, the vision system 740, associated with the bonder, is activated again as the second input data generator 742. The input generator collects images of the actual location of the bond attached to the sacrificial pad. The data from the second input generator 742 are forwarded to the image comparator 750.

Image comparator 750 is coupled to the vision system 740 associated with the bonder. It compares the input information submitted by the first data generator 741 and the second data generator 742. Based on this comparison of the images, any error between the intended bond location and the actual bond location is determined. The result of this comparison is forwarded to the command module 730 of the bonder.

The second command module 732, located with the bonder command module 730, is coupled to the image comparator 750 from which it receives the information of any bond position error determined by comparator 750. Based on this input, the second command module 732 computes a new command of the bonder such that a repetition of the initial error would cause a new bond to be located in the actual center of another pad chosen as a pad-to-be-bonded.

Finally, the new command is input into the bonder so it can form a second corrected bond 761 exactly at the desired location.

Other Embodiments

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

As an example, the invention discloses a computer-implemented method for identifying and correcting action errors on a machine pre-programmed to perform mechanical action onto an action site of an object, the machine having an associated vision system, comprising the steps of:

providing a sacrificial action site for a sacrificial mechanical action;

using the vision system to determine the actual center of the action site as the intended action location;

instructing the machine to perform the action in the pre-programmed center of said action site;

using the vision system to determine the actual location of the action;

determining the error between the intended action location and the actual action location by computing distances and directions between the pre-programmed and actual centers and the actual action location;

computing a new command of the machine such that a repetition of the initial error would cause the action to be located in the actual center of another action site; and

inputting the new command to the machine.

This method has a number of more detailed process steps. The step of determining the error comprises the steps of:

choosing an origin a s point of reference;

computing distance and direction of the preprogrammed center form said origin;

computing distance and direction of the actual action location from the pre-programmed center;

computing distance and direction of the actual center from the pre-programmed center; and

computing distance and direction of the actual center from the actual action location.

Furthermore, the step of computing the new command comprises the steps of:

computing a new center of the action site by adding to the location of the pre-programmed center the distance and the direction of the actual center from the actual action location; and

implementing the new center into the machine as the corrected pre-programmed center.

I claim:

1. A computer-implemented method for identifying and correcting bond placement errors in a bonder pre-programmed to attach connecting bonds onto bond pads of an integrated circuit, said bonder having an associated vision system, comprising the steps of:
providing a sacrificial bond pad for a sacrificial bond;
using said vision system to determine the actual center of said pad as the intended bond location;
instructing said bonder to place said bond in the pre-programmed center of said pad;
using said vision system to determine the actual location of said bond;
determining the error between said intended location and said actual location by computing distances and directions between said pre-programmed and actual centers and said actual bond location;
computing a new command of said bonder such that a repetition of said initial error would cause said bond to be located in the actual center of another pad; and
inputting said new command to said bonder.

2. The method according to claim 1 wherein said step of determining the error comprises the steps of:
choosing an origin as point of reference;
computing distance and direction of said preprogrammed center form said origin;
computing distance and direction of said actual bond location from said pre-programmed center;
computing distance and direction of said actual center from said pre-programmed center; and
computing distance and direction of said actual center from said actual bond location.

3. The method according to claim 1 wherein said step of computing said new command comprises the steps of:
computing a new center of said pad by adding to the location of said pre-programmed center said distance and said direction of said actual center from said actual bond location; and
implementing said new center into said bonder as the corrected pre-programmed center.

4. The method according to claim 1 further comprising the step of repeating the sequence of steps with a predetermined periodicity.

5. The method according to claim 4 wherein said periodicity includes for each bond, once for every chip, or after a pre-defined number of chips.

6. The method according to claim 1 wherein said bond placement errors include gradual and systematic errors as well as random and unpredictable errors.

7. The method according to claim 1 wherein said bond includes ball bond, wedge bond, stitch bond, and ball using wires, ribbons, and bumps.

8. A computer-implemented method for identifying and correcting action errors in a machine pre-programmed to perform mechanical action onto an action site of an object, said machine having an associated vision system, comprising the steps of:
providing a sacrificial action site for a sacrificial mechanical action;
using said vision system to determine the actual center of said action site as the intended action location;
instructing said machine to perform said action in the pre-programmed center of said action site;
using said vision system to determine the actual location of said action;
determining the error between said intended action location and said actual action location by computing distances and directions between said pre-programmed and actual centers and said actual action location;
computing a new command of said machine such that a repetition of said initial error would cause said action to be located in the actual center of another action site; and
inputting said new command to said machine.

9. The method according to claim 8 wherein said step of determining the error comprises the steps of:
choosing an origin a s point of reference;
computing distance and direction of said preprogrammed center form said origin;
computing distance and direction of said actual action location from said pre-programmed center;
computing distance and direction of said actual center from said pre-programmed center; and
computing distance and direction of said actual center from said actual action location.

10. The method according to claim 8 wherein said step of computing said new command comprises the steps of:
computing a new center of said action site by adding to the location of said pre-programmed center said distance and said direction of said actual center from said actual action location; and
implementing said new center into said machine as the corrected pre-programmed center.

11. A computerized system for identifying and correcting bond placement errors in a bonder pre-programmed to attach connecting bonds onto bond pads of an integrated circuit, said bonder having an associated vision system, comprising:
a pre-generated device program file operable to store a master bond program used for said preprogramming;
a retriever, coupled to said device program file, operable to regenerate said master program and to relate said program to alignment references;
a first input data generator, coupled to said vision system associated with said bonder, operable to generate images of a sacrificial, still empty bond pad as input information for the actual center of said bond pad;
a first bonder command module, coupled to said retriever, operable to instruct the bonder to place a bond intended for the pad center according to said pre-program;
a second input data generator, coupled to said vision system associated with said bonder, operable to generate images of the actual location of said bond within said pad;
an image comparator, coupled to said vision system associated with said bonder, operable to determine the error between said intended bond location and said actual bond location;
a second bonder command module, coupled to said bonder and to said image comparator, operable to compute a new command of said bonder such that a repetition of said initial error would cause said bond to be located in the actual center of another pad; and
a corrector, coupled to said bonder, operable to input said new, corrected command, to said bonder.

12. The system according to claim 11 wherein said first and said second input data generators are integral with said vision system associated with said bonder.

13. The system according to claim 11 wherein said error is determined by computing distances and directions between said pre-programmed and actual centers and said actual bond locations.

14. A computerized system for identifying and correcting action placement errors on a machine pre-programmed to perform mechanical action onto an action site of an object, said machine having an associated vision system, comprising:
a pre-generated object program file operable to store a master action program used for said preprogramming;
a retriever, coupled to said object program file, operable to regenerate said master program and to relate said program to alignment references;
a first input data generator, coupled to said vision system associated with said machine, operable to generate images of a sacrificial, still empty action site as input information for the actual center of said action site;
a first machine command module, coupled to said retriever, operable to instruct the machine to place an action intended for the site center according to said pre-program;
a second input data generator, coupled to said vision system associated with said machine, operable to generate images of the actual location of said action within said site;
an image comparator, coupled to said vision system associated with said machine, operable to determine the error between said intended action location and said actual action location;
a second machine command module, coupled to said machine and said image comparator, operable to compute a new command of said machine such that a repetition of said initial error would cause said action to be located in the actual center of another pad; and
a corrector, coupled to said machine, operable to input said new, corrected command, to said machine.
